(19) United States
(12) Patent Application Publication
(10) Pub. No.: US 2015/0123801 A1
(43) Pub. Date: May 7, 2015

(54) MONITORING THE STATE OF A BEEHIVE

(71) Applicant: Eltopia Communications, LLC, Seattle, WA (US)

(72) Inventors: Richard Eloy de Leon, Seattle, WA (US); Will Lee MacHugh, Seattle, WA (US); Aaron Robert Seelye, Seattle, WA (US); Joseph M. Murphy, Seattle, WA (US); Duncan Smith, Seattle, WA (US); Thomas Moxon, Portland, OR (US); Thomas Hudson, Portland, OR (US); Marla Spivak, St. Paul, MN (US)

(21) Appl. No.: 14/530,148

(22) Filed: Oct. 31, 2014

Related U.S. Application Data
(60) Provisional application No. 61/899,042, filed on Nov. 1, 2013.

(51) Int. Cl. A01K 47/06

(52) U.S. Cl. CPC A01K 47/06
USPC 340/573.3

(57) ABSTRACT

A system for monitoring the state of a beehive comprises multiple gates configured to be positioned proximate to an entrance of a beehive. Each gate includes one or more sensors configured to capture information indicating a bee is within the gate and information indicating the bee is traveling toward or away from the entrance to the beehive. In addition, each gate includes a sensor configured to capture information identifying the size or shape of a bee within the gate. A corresponding method and computer readable medium are also disclosed.

### CROSS REFERENCE TO RELATED APPLICATIONS

The present application claims benefit under 35 U.S.C. §119(e) of U.S. Provisional Patent Application No. 61/899,042, filed Nov. 1, 2013, the content of which is incorporated herein by reference in its entirety.

### TECHNICAL FIELD

The disclosed invention relates generally to the field of agriculture, and more particularly to a system for monitoring the state of a beehive.

### SUMMARY

A system for monitoring the state of a beehive in accordance with an illustrative embodiment of the present invention comprises multiple gates configured to be positioned proximate to an entrance of a beehive. Each gate includes one or more sensors configured to capture information indicating a bee is within the gate and information indicating the bee is traveling toward or away from the entrance to the beehive. In addition, each gate includes a sensor configured to capture information identifying the size or shape of a bee within the gate. A corresponding method and computer readable medium are also disclosed.

In presently preferred embodiments, the one or more sensors include two or more infrared photo transistors, and at least one interior surface of the gate is black.

Moreover, the sensor configured to capture information identifying the size or shape of a bee within the gate is an RGB phototransistor. Alternatively, this sensor may be an infrared phototransistor. Advantageously, the sensor may also be configured to capture information indicative of a mite attached to the bee within the gate, and/or may be configured to capture information indicative of one or more other biological substances attached to the bee within the gate. For example, such biological substances may include pollen, water, nectar, propolis, fungus, and so on.

The preferred embodiments include temperature sensing circuitry enabling the system to detect when the cells are capped, which can be used to trigger a treatment process. For example, the capped cells may be treated with localized heat, or it is possible that a more advantageous treatment would be to apply a chemical treatment to the cells. Such treatment may be designed, e.g., to sterilize the mites. In this regard, the ability to detect when the cells are capped is an important feature of the disclosed system.

Inventive methods and computer readable media are also described below.

### BRIEF DESCRIPTION OF THE DRAWINGS

FIG. 1 is a block diagram illustrating components of a suitable computing environment.

FIG. 2 is a block diagram illustrating aspects of a bee identification device.

FIG. 3 is a block diagram illustrating components of a hive monitoring system.

FIG. 4 is a flow diagram illustrating a method for identifying a bee within a gate.

FIG. 5 is a flow diagram illustrating a method for identifying an object attached or proximate to a bee within a gate.

FIG. 6 is a flow diagram illustrating a method for performing an action based on a state of a beehive.

FIG. 7 is a flow diagram illustrating a method for sterilizing and/or interrupting the lifecycle of mites within a beehive.

FIG. 8 is a diagram illustrating a matte finish Compostable Circuit Board with thirty-two (32) individually operated heating elements.

FIG. 9 is a diagram illustrating one of the 32 Hilbert Curve Heating Elements on each Compostable Circuit Board.

FIG. 10 is a diagram illustrating a process for detecting temperature at the base of the comb.

FIG. 11 is a diagram showing the use of multi-layered compostable film for the Compostable Circuit Board using different inks.

FIG. 12 is a diagram illustrating a method and process for applying wax to a Compostable Circuit Board.

FIG. 13 is a diagram illustrating the use of a Programmable System-on-Chip.

### DETAILED DESCRIPTION OF ILLUSTRATIVE EMBODIMENTS

In the following sections, we will describe presently preferred embodiments of our inventive systems and methods for monitoring the state of a beehive. We first provide an overview of the technology, and then we provide a detailed description of the inventive embodiments.

### Overview

Systems and methods for monitoring beehives are described. In some examples, the systems and methods may receive, and/or access information captured, collected, and/or measured by a device positioned proximate to a beehive, such as proximate to the entrance of a beehive. The device may capture and/or measure information indicative of whether a bee entered/exited the beehive, as well as information indicative of the type of bee that entered/exited the beehive, information indicative of an object (e.g., a mite or biological substance) attached to the bee, and so on.

In some examples, the device may include multiple gates configured to be positioned proximate to the entrance of a beehive. The gates may include one or more sensors (e.g., “bee counter sensors”) configured to capture information indicating a bee is within the gate and information indicating the bee is traveling toward or away from the entrance to the beehive, and a sensor (e.g., “identification sensor”) configured to capture information identifying a size or shape of a bee within the gate, among other things. As an example, a bee counter sensor may be an infrared phototransistor, and an identification sensor may be an RBG (red, blue, green) phototransistor, among other sensors.

The systems and methods may perform various actions based on information captured by the device. For example, the systems and methods may determine a state or states of a beehive based on information captured by the device, and generate reports and/or alerts when a current or predicted state of the beehive is determined to be abnormal or different from a baseline, standard, known, or expected state of the beehive.

The systems and methods will now be described with respect to various embodiments. The following description provides specific details for a thorough understanding of, and enabling description for, these embodiments of the systems and methods. However, one skilled in the art will understand that the systems and methods may be practiced without these details. In other instances, well-known structures and functions have not been shown or described in detail to avoid unnecessarily obscuring the description of the embodiments of the systems and methods.

It is intended that the terminology used in the description presented below be interpreted in its broadest reasonable manner, even though it is being used in conjunction with a detailed description of certain specific embodiments of the systems and methods. Certain terms may even be emphasized below; however, any terminology intended to be interpreted in any restricted manner will be overtly and specifically defined as such in this Detailed Description section.

### Suitable System

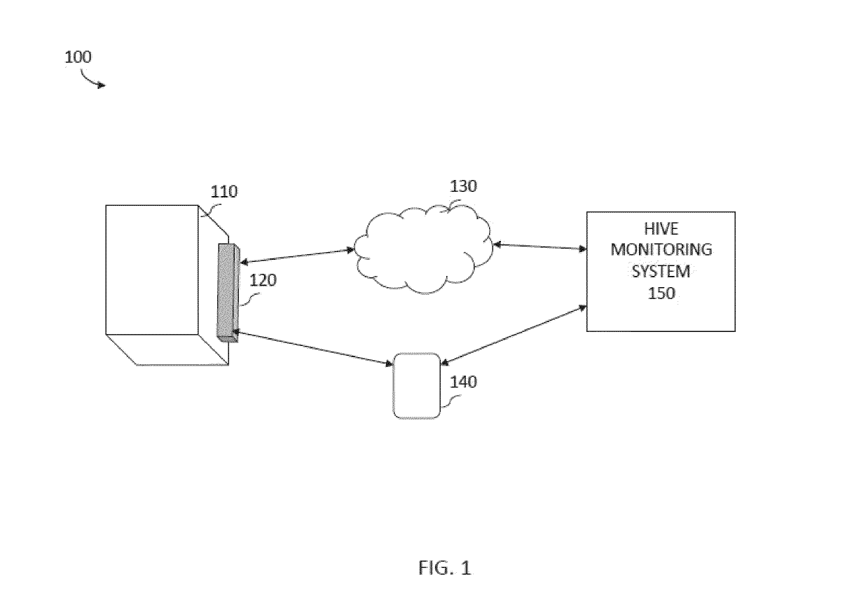

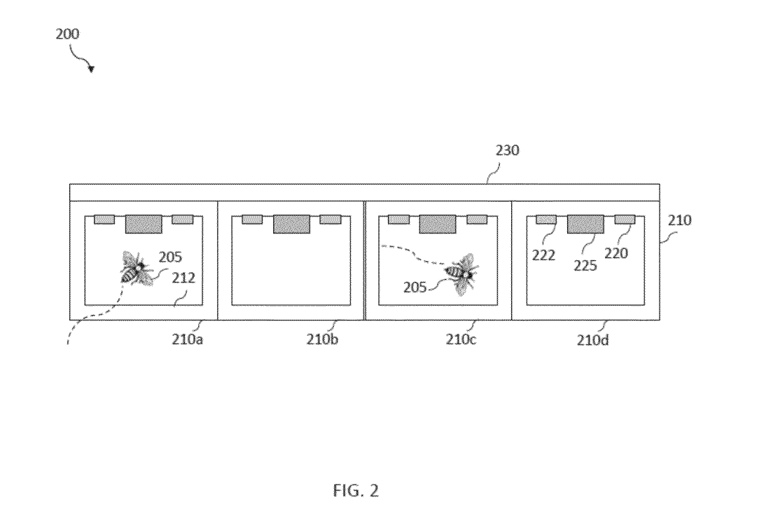

As described herein, a hive monitoring system is described. FIG. 1 illustrates components and devices within a suitable computing environment 100 in which a hive monitoring system 150 may be supported and/or implemented. The computing environment 100 includes a bee identification device 120 positioned proximate to a beehive 110. The bee identification device 120 may include various gates (shown in FIG. 2) positioned proximate to an entrance/exit to the beehive 110. The bee identification device 120 may include various sensors, light emitters (light emitting diodes, or LEDs) and other data or information collection or measurement devices configured to collect, capture, and/or measure information associated with the beehive 110, such as information associated with a current or predicted state of the beehive (e.g., a number of bees within the beehive 110, a number of bees outside of the beehive 110, the type of bees within/outside the beehive 110, a number of foreign objects (e.g., mites, pollen and other biological substances, and so on), and so on.

A data collection device 140, such as a smartphone or other mobile device, may receive, extract, and/or otherwise access data or information collected by the bee identification device 120. The data collection device 140 may collect data in a variety of ways, such as via direct communications (e.g., BLUETOOTH™).

A hive monitoring system 150 may receive, collect, and/or otherwise access data or information collected by the bee identification device 120, such as directly from the data collection device 140 and/or via a network 130, such as the Internet. For example, the data collection device 140 may collect data from bee identification devices 120 located in geographical areas having limited or poor telecommunications coverage, and provide the data to the hive monitoring system 150. As described herein, the hive monitoring system 150 may include various components and perform various methods to count bees entering or exiting the beehive 110, identify bees entering or exiting the beehive 110, perform actions based on a determined state of the beehive 110, and so on.

The data collection device 140 and/or the hive monitoring system 150 may be and/or supported by a tablet computer, mobile device, smart-phone, net-book, mobile GPS navigation device, fixed telephone or communications console or apparatus, surface or tabletop computer, desktop computer, server computer, or any computing system. The data collection device 140 and/or the hive monitoring system 150 may include various hardware and/or software components in order to provide such functionality. For example, the data collection device 140 and/or the hive monitoring system 150 may include various human interface components, device components, and memory, and so on. The network 130 may be a Local Area Network (LAN), a Wide Area Network (WAN), the Internet, a telecommunications network, a satellite-based network, or other networks capable of facilitating various communications between computing devices.

FIG. 1 and the discussion herein provide a brief, general description of a suitable computing environment in which the hive monitoring system 150 and/or the bee identification device 120 can be supported and implemented. Although not required, aspects of the system/device are described in the general context of computer-executable instructions, such as routines executed by a general-purpose computer, e.g., mobile device, a server computer, or personal computer. Those skilled in the relevant art will appreciate that the system can be practiced with other communications, data processing, or computer system configurations, including: Internet appliances, hand-held devices (including tablet computers and/or personal digital assistants (PDAs)), all manner of cellular or mobile phones, multi-processor systems, microprocessor-based or programmable consumer electronics, set-top boxes, network PCs, mini-computers, mainframe computers, and the like. Indeed, the terms “computer,” “host,” and “host computer,” and “mobile device” and “handset” are generally used interchangeably herein, and refer to any of the above devices and systems, as well as any data processor.

Aspects of the device/system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the device/system may be stored or distributed on computer-readable media (e.g., physical and/or tangible computer-readable storage media), including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the system may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the system reside on a server computer, while corresponding portions reside on a client computer such as a mobile or portable device, and thus, while certain hardware platforms are described herein, aspects of the system are equally applicable to nodes on a network. In an alternative embodiment, the mobile device or portable device may represent the server portion, while the server may represent the client portion.

As described herein, in some examples, the bee identification device 120 is configured to count and/or identify types of bees that enter or exit the beehive 110, as well as other objects that enter or exit the beehive 110, such as objects attached to or proximate to entering/exiting bees, among other things. FIG. 2 is a block diagram illustrating aspects of the bee identification device 200.

The device 200 includes multiple gates 210a-d, which, when positioned proximate to an entrance of the beehive 110, are configured to cause bees to travel through a gate 210 when entering or exiting the beehive 110. For example, a bee 205 enters the gate 210a in order to enter the beehive 110, and exits via gate 210c in order to exit the beehive 110. The gates 210 include an interior or inside, formed by surfaces 212 that include various sensors 220, 225 positioned within the gate 210 in order to capture information associated with the bee 205 that enters the gate 210. The surfaces 212 may be formed with a variety of patterns or colors in order to facilitate and/or improve the capture of information by the sensors 220, 225. For example, the sensors 220, 225 may be phototransistors, and the surfaces may be black or opaque to improve the resolution or other characteristics of images of the bee 205 that are captured by the phototransistors.

As described herein, in some examples, each gate 210 of the device 200 includes a light emitter (e.g., LED) 222, bee counter sensors 220 and an identification sensor 225. For example, the gate 210d includes an LED 222, a bee counter sensor, such as infrared (RF) phototransistor configured to measure reflectance, and one identification sensor 225, such as an RGB phototransistor. Using these sensors, the device 200 may be a system capable of detecting and identifying bees 205 and other objects that travel through the gates 210 of the device 200 and into or out of the beehive 110. For example, the system provided by the device may include one or more gates configured to be positioned proximate to an entrance of a beehive, where each gate includes one or more sensors configured to capture information indicating a bee is within the gate and information indicating the bee is traveling toward or away from the entrance to the beehive (e.g., the bee counter sensors 220), and a sensor configured to capture information identifying a size or shape of a bee within the gate (e.g., the identification sensor 225).

In some examples, the sensor 220 is an RF photodiode configured to detect the presence and/or movement of an object (e.g., the bee 205) within the gate 210 by determining and/or measuring differences in light within the gate. Using the sensor 220, the device 200 may capture information indicating a difference in illumination when a bee 205 enters the gate 210 and is illuminated by light emitted from the LED 222, which may indicate the presence of the bee 205 within the gate. Using two sensors 220 (not shown), the device 200 may capture information indicating a difference in illumination as well as a pattern of the illumination, which may indicate the presence of the bee 205 within the gate as well as the direction (e.g., in or out of the gate 210) the bee 205 is traveling.

In some examples, the sensor 225 is an RGB photodiode configured to detect the size and/or shape of objects (e.g., a bee 205) within the gate 210, by determining and/or measuring differences in colors of objects within the gate 210. For example, the LED 222 may emit light to effectively scan the detected object, and the RGB photodiode may capture information that indicates a shape or size of the bee 205 within the gate, such as information that identifies different colors or color patterns for various parts of the bee 205. The sensor 225 may also capture information that indicates the presence of other objects within the gate 210, such as mites attached to the bee 205, biological substances (e.g., pollen, mites, water, nectar, propelys, fungus, and so on) attached to the bee 205, and so on, based on various measured color patterns.

Of course, the gate 210 may include other sensors not shown, such as chemical sensors configured to detect the presence of certain chemicals and/or substances within the gate 210, environmental sensors, additional phototransistors, and so on.

In some examples, the device 210 includes an electronic assembly 230 that includes components which provide power to the gates 210 and their internal sensors 220, 225, store information, transmit and/or receive information, and so on. For example, the electronic assembly 230 may include one or more batteries or solar panels, one or more processors, one on more data storage devices, communication busses, data busses, communication components (e.g., Wi-Fi or BLUETOOTH™ antennas), and so on.

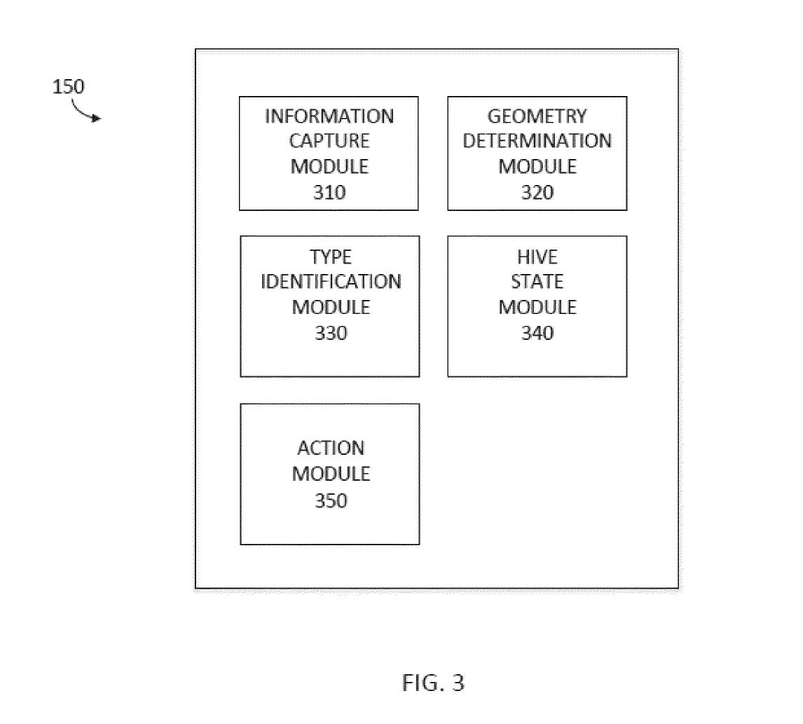

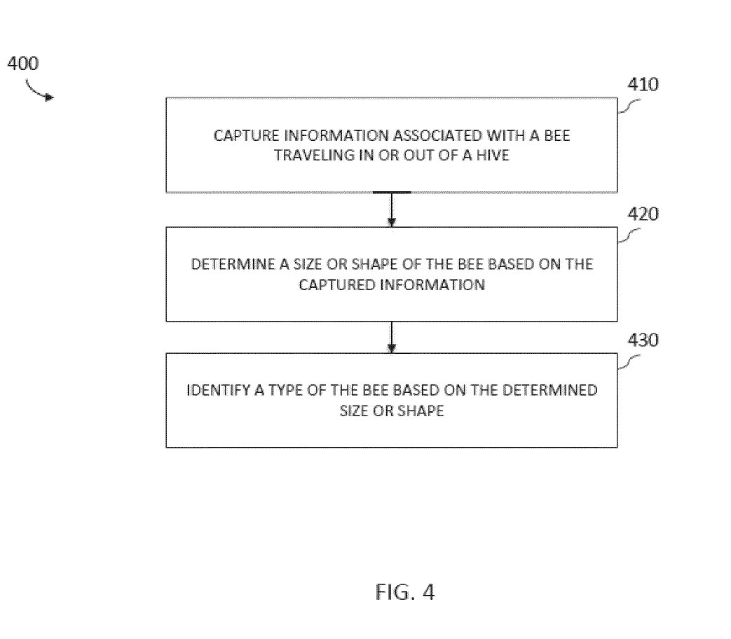

As described herein, in some examples, the bee identification device 120 captures information associated with bees entering and/or exiting the beehive 110, and provides such information to the hive monitoring system 150. FIG. 3 is a block diagram illustrating components of the hive monitoring system 150. The hive monitoring system 150 includes a variety of functional modules, such as an information capture module 310, a geometry determination module 320, a type identification module 330, a hive state module 340, and an action module 350. In some examples, the various modules of the hive monitoring system 150 may perform some or all of the methods described herein, such as those described in FIGS. 4-6.

One skilled in the art will appreciate that the functional modules are implemented with a combination of software (e.g., executable instructions, or computer code) and hardware (e.g., at least a memory and processor). Accordingly, as used herein, in some examples a module is a processor-implemented module and represents a computing device having a processor that is at least temporarily configured and/or programmed by executable instructions stored in memory to perform one or more of the particular functions that are described herein.

As described herein, in some examples, the hive monitoring system 150 performs various algorithms, routines and/or methods in order to determine a state of a beehive and to perform various actions associated with the determine state of the beehive. FIG. 4 is a flow diagram illustrating a method 400 for identifying a bee within a gate.

In step 410, the hive monitoring system 150 captures and/or accesses information associated with a bee traveling in or out of a beehive. For example, the hive monitoring system 150 may access information captured by the device 200, such as information when the bee is within a gate proximate to a beehive, via the one or more sensors 220 configured to capture information indicating the bee is within the gate and information indicating the bee is traveling toward or away from the entrance to the beehive, and via the sensor 225 configured to capture information identifying a size or shape of a bee within the gate.

In step 420, the hive monitoring system 420 determines a size or shape of the bee based on the captured information. For example, the hive monitoring system 150 may access information measured or scanned by the sensor 225, such as color patterns and the extent of the measured patterns, to determine a size or geometry of the bee 205 within the gate 210.

In step 430, the hive monitoring system 150 identifies a type of the bee based on the determined size or shape of the bee. For example, the hive monitoring system 150 may match the information identifying a shape, geometry or size of the bee 205 to a table or other data structure that stores information relating types of bees (e.g., drone, worker, forager, and so on) to their known sizes and/or shapes (e.g., their overall shape and/or a shape of one or more body parts of the bee).

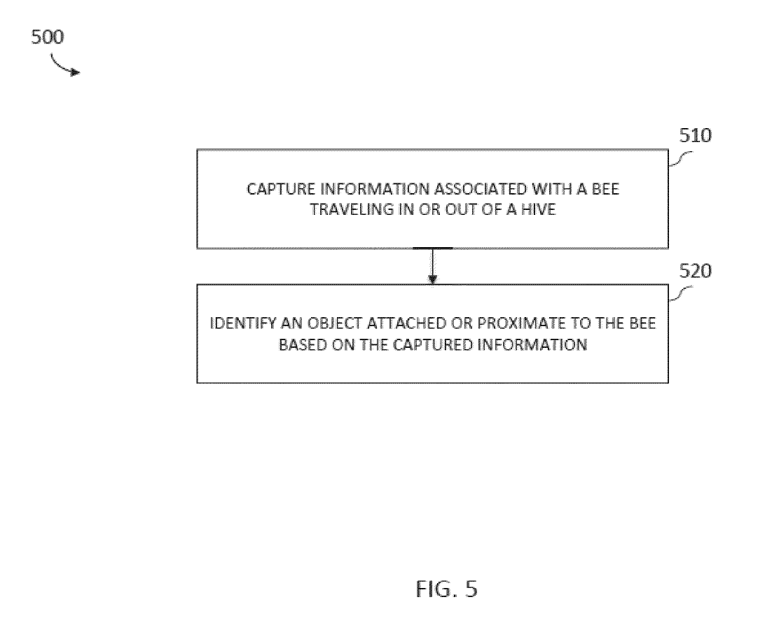

As described herein, the hive monitoring system 150 may utilize information captured by the bee identification device 120 to identify and/or monitor the presence and/or movement of foreign objects in and out of the beehive 110. FIG. 5 is a flow diagram illustrating a method 500 for identifying an object attached or proximate to a bee within a gate.

In step 510, the hive monitoring system 150 captures information associated with a bee traveling in or out of a beehive. For example, the hive monitoring system 150 captures the information when the bee is within a gate proximate to a beehive via one or more sensors 220 configured to capture information indicating the bee is within the gate and information indicating the bee is traveling toward or away from the entrance to the beehive, and via the sensor 225 configured to capture information indicating the object is attached or proximate to the bee.

In step 520, the hive monitoring system 150 identifies an object attached or proximate to the bee based on the captured information. For example, the hive monitoring system 150 may determine a captured color pattern is indicative of pollen that is attached to the bee, is indicative of a mite that is attached to the bee, and so on.

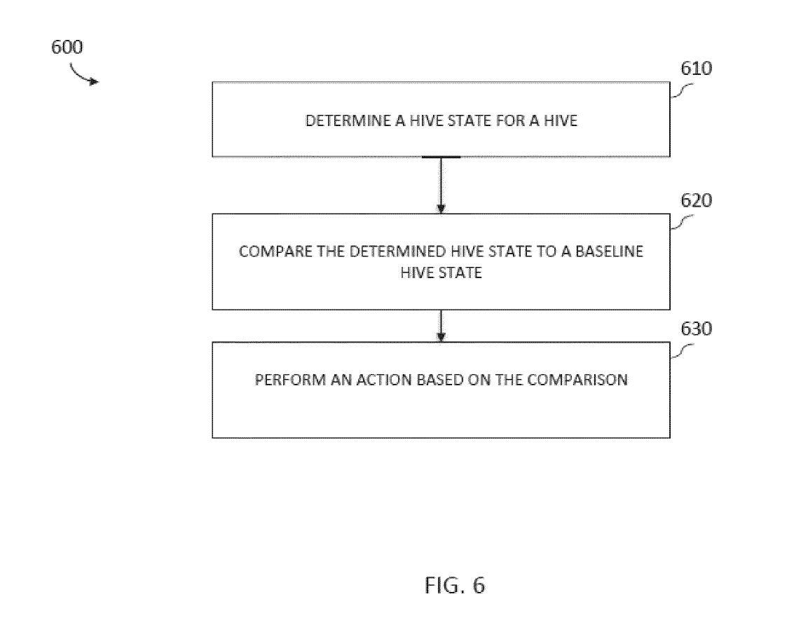

As described herein, the hive monitoring system 150 may determine a state of a beehive and/or perform actions based on the determined state of the beehive, among other things. FIG. 6 is a flow diagram illustrating a method 600 for performing an action based on a state of a beehive.

In step 610, the hive monitoring system 150 determines a hive state for a beehive. For example, the hive monitoring system 150 may use information captured by the bee identification device 120 to determine, for a first type of bee, a number of bees of the first type within the beehive and a number of bees of the first type outside of the beehive, and determine, for a second type of bee, a number of bees of the second type within the beehive and a number of bees of the second type outside of the beehive.

As another example, the hive monitoring system 150 may use information captured by the bee identification device 120 to determine a number of bees within the beehive 110 and determine a number of bees outside of the beehive 110 (as compared to a known or expected range of bees associated with the beehive 110), to determine a number of bees having attached mites within the beehive, to determine an amount of pollen with the beehive, and so on.

In step 620, the hive monitoring system 150 compares the determined hive state to a baseline hive state. For example, the hive monitoring system 150 may compare a current state of the beehive 110 (e.g., number of bees within the beehive 110) to an expected or baseline state of the beehive 110 (e.g., an expected number of bees within the beehive 110).

In step 630, the hive monitoring system 150 performs an action based on the comparison. For example, the hive monitoring system 150 may generate a report that indicates the determined hive state is abnormal or otherwise includes one or more unexpected parameters, may generate an alert that indicates the determined hive state is abnormal or otherwise includes one or more unexpected parameters, and/or generates a report that indicates an abnormal or unexpected condition associated with a crop proximate to the beehive and pollinated by at least one bee of the beehive.

For example, the hive monitoring system 150 may determine a current number of worker bees within a beehive and a current number of worker bees outside of the beehive, where the beehive has a known range of a total number of worker bees associated with the beehive, may determine a current number of drone bees within a beehive and a current number of drone bees outside of the beehive, where the beehive has a known range of a total number of drone bees associated with the beehive, and perform an action based on the determined numbers.

Thus, in some examples, the hive monitoring system 150 may utilize various types of information collected and/or measured by the device 120 in order to determine a vitality or state of the beehive 110. Such information may indicate a variety of current and/or predicted parameters for the colony associated with the beehive 110, such as different vitality levels, current or anticipated swarm activities outside of the beehive 110, mite levels within the beehive 110, exit and/or entry traffic or patterns, levels of pollination for crops within areas proximate to or otherwise associated with the beehive 110 (e.g., based on detected amounts of pollen with the beehive 110 and/or bee traffic patterns), crop level predictions, pollination management, and so on.

In some examples, the hive monitoring system 150 may include various components and perform various processes in order to selectively reduce an amount of mites within the beehive 110. For example, the hive monitoring system 150 may determine an amount of mites within a beehive (e.g., an estimated or predicated range of the number or percentage of mites within the beehive 110), and cause a mite elimination system within the beehive 110 to selectively interrupt the lifecycle (e.g., sterilize) and/or remove mites from the beehive 110.

In a beehive 110, in order to generate a brood of bees, a queen bee lays eggs into many cells of the frames of the beehive 110, which become brood chambers. Once the eggs begin to hatch, worker bees apply royal jelly to feed the newly hatching larvae. After eating through the jelly, the larvae begin to grow into their cells, and older bees begin to cap their cells as they enter the pupae stage. Just before they are capped, mites may enter the cells and reproduce within the capped cells, often destroying the colony of bees within the beehive 110.

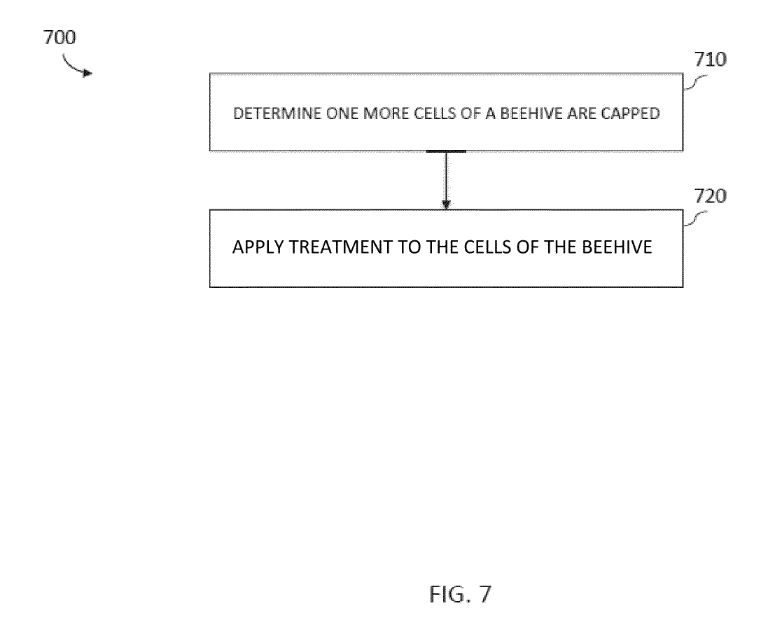

FIG. 7 is a flow diagram illustrating a method 700 for sterilizing and/or interrupting the lifecycle of mites within a beehive. In step 710, the hive monitoring system 150 detects one or more brood chamber cells of the beehive 110 are capped. For example, temperature sensors placed proximate to cells or cones of a frame (e.g., on or within a foundation of a frame of the beehive 110) may detect a small change in temperature of the cells of the frame when the cells are capped due to a slowing of a bee's diurnal cycle, indicating the cells are capped.

In step 720, the hive monitoring system 150 applies, or causes to be applied at any given speed, a treatment, such as localized heat to the comb of the capped cells. The localized heat treatment may be applied using a controller, which may be configured, e.g., as a proportional-integral-derivative (“PID”) controller. A PID controller allows the hive monitoring system 150 to determine the necessary speed to ramp up and down the heating elements (which may be configured as Hilbert Curve Heating Elements disposed along a continuous curve that is fractal and self-similar). Additionally, the PID controller targets and sustains exact temperatures. For example, heating elements placed proximate to the cells (e.g., on or within the foundation of the frame) may apply heat to the cells once they have been capped, which may cause sterilization and/or interrupt the lifecycle of some or all mites without harming the pupa stage bees also within the cells. Using the PID controller enables the hive monitoring system 150 to heat the element to the necessary and sustainable temperature before the mite can avoid the heat. (In other words, the mites may move when they feel heat. We have developed the heating elements so that we can ramp the temperature quickly so our treatment is effective before the mite has a chance to move out of the way.) It should also be noted that, instead of treating the capped cells with localized heat, it is possible that a more advantageous treatment would be to apply a chemical treatment to the cells, e.g., to sterilize the mites. Therefore, knowing when the cells are capped or uncapped is an important feature of the disclosed system.

A technical advantage of using a Hilbert curve in the design of a heating element allows for the even distribution of heat across the surface, to avoid under-heating some mites and over-heating others. Moreover, use of many heating elements provides the advantage of allowing us to reduce the amount of power required to produce heat, i.e., since smaller areas make it easier to keep temperatures even. Additionally, the use of a multi-layer film allows us to produce heating elements with no space between the elements and therefore avoid missing any surface area to heat.

We have selected a conductor in the Hilbert curve elements that allows us to apply current to heat the element and then take measurements of current to estimate temperature. This allows us to avoid having to use separate heating elements and thermistors. However, instead of using Hilbert curve elements, one could add a layer of thermisters to detect temperature cycles for cap detection.

As an example, given a normal cell temperature of 93 degrees Fahrenheit, the hive monitoring system 150 may cause the cells to be locally heated to temperatures 10-20 degrees warmer (e.g., to temperatures up to 113 degrees F.), which may be sufficient to sterilize and/or interrupt the lifecycle of some or all mites within brood chambers without harming (or limiting the harm) to the rest of the colony.

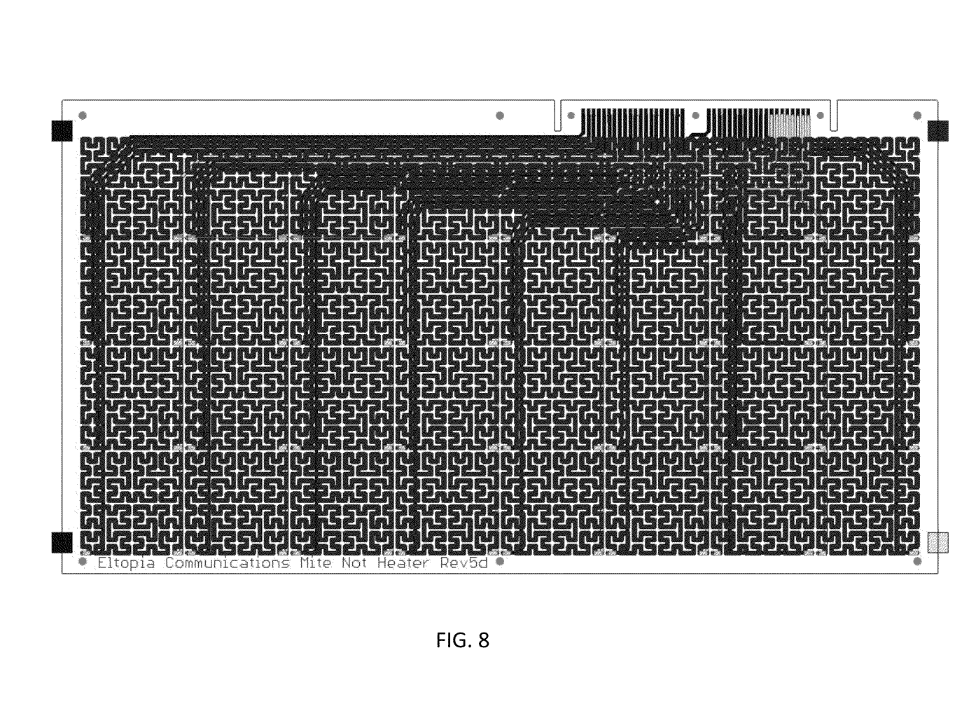

FIG. 8 is a diagram illustrating a matte finish Compostable Circuit Board with thirty-two (32) individually operated heating elements that emit low levels of radiant thermal (heat). Using a matte finish on the circuit board enables wax to stick to the compostable material. Compostable materials and Hilbert Curve Heating Elements emitting low levels of heat enable the bees to build on that material while being environmentally friendly. The use of thirty-two 32 Hilbert Curve Heating Elements on each circuit board enables the device to selectively heat isolated sections of the comb once cap detection has taken place. Selectively determining appropriate elements to heat and then heating those isolated elements provides the advantage of reducing power consumption, mitigating potential harm to the Pupa and regulating hive temperature.

We have chosen to work with a compostable film called PLA. Other films could work but PLA has the benefit of being compostable. PLA and other films have low or no emissivity when heated, which is critical so that the bees actually want to draw comb on the film. In addition, it is important for the film to have a matte finish so that the wax will stick to the film.

The wax and the design of the cells are embossed onto the board, allowing the size and quantity of cells to be varied. This feature offers the technical advantage of allowing us to make cells for just drones, just workers, or combinations. This may be useful for other species of bees.

It should also be noted that different films destabilize at different temperatures. If the PLA film or other film is determined to destabilize at too low a temperature, conductive inks or conductive adhesives may be needed to construct the heating elements. The temperature of the ink has to cure below the temperature of the destabilization point of the film. Also, different inks may be used in the film. For example, a less resistive conductive ink may be used between the heating elements and a compounded ink that is more resistive may be used in the actual heating elements.

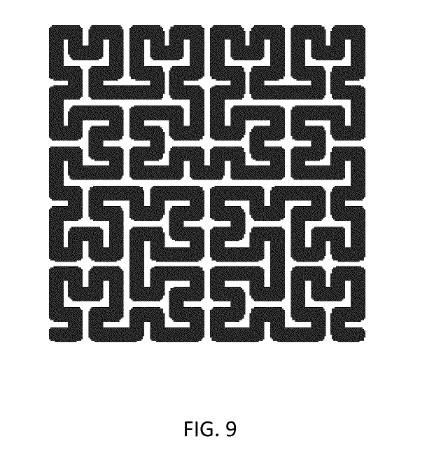

FIG. 9 is a diagram illustrating one of the 32 Hilbert Curve Heating Elements on each Compostable Circuit Board. As mentioned above, the use of the Hilbert Curve provides for even and stable distribution of heat across the surface of each element.

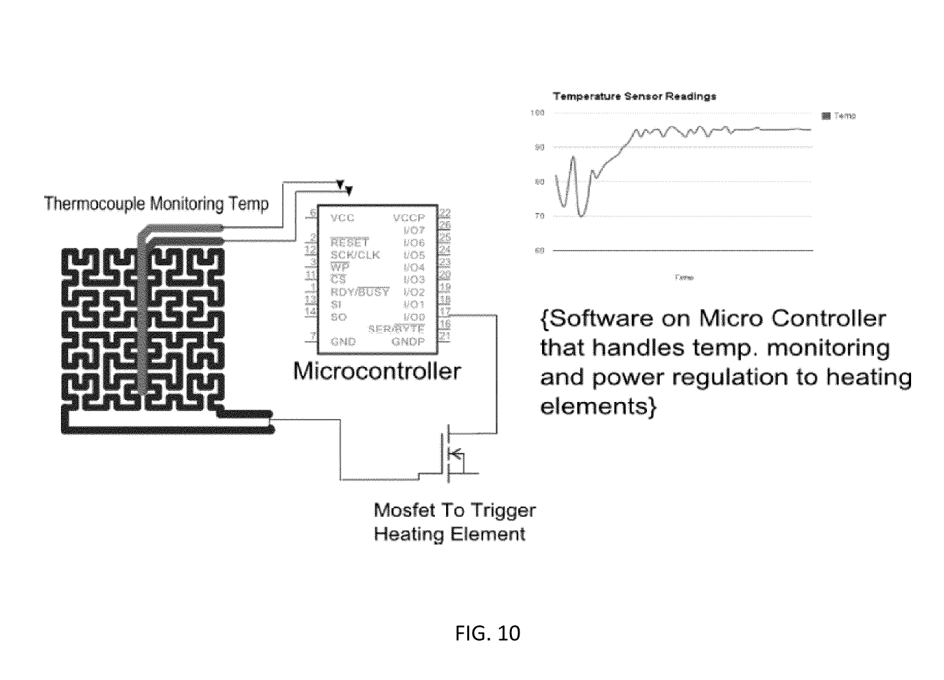

FIG. 10 is a diagram illustrating the process for detecting temperature at the base of the comb. For example, a queen will lay her brood in the comb, which will get capped by a worker bee. Once capped, the temperature fluctuation changes in that comb. Using a conductor in the Hilbert Curve Heating Elements enables the hive monitoring system 150 to take necessary temperature measurements of the comb close to the brood. In turn, this enables the hive monitoring system 150 to detect temperature fluctuation at the base of the comb. The temperature fluctuation is indicative of the diurnal cycle of bees allowing the hive monitoring system 150 to begin treating for mite infestation and other potential necessities. Moreover, there is a distinct difference to the fluctuation of temperature between capped and uncapped cells. We use this to know when the caps are on so that we can begin treatments.

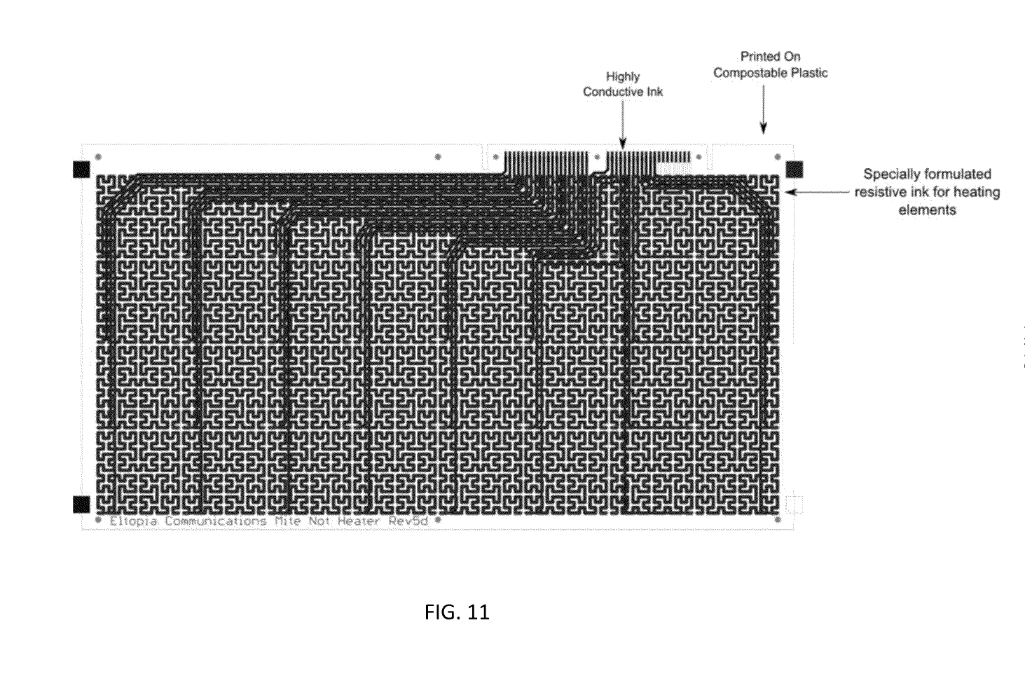

FIG. 11 is a diagram showing the use of multi-layered compostable film for the Compostable Circuit Board using different inks that require specific resistance and conductivity. This process allows the Hilbert Curve Heating Elements to be placed on the Compostable Circuit Board with little to no space between each element. These inks will cure at a temperature that is below the destabilization temperature of the Compostable Circuit Board. The ink used for the Hilbert Curve Heating Elements is less conductive and more resistant. The ink for the traces leading to each Hilbert Curve Heating Element is the opposite, being more conductive with less resistance.

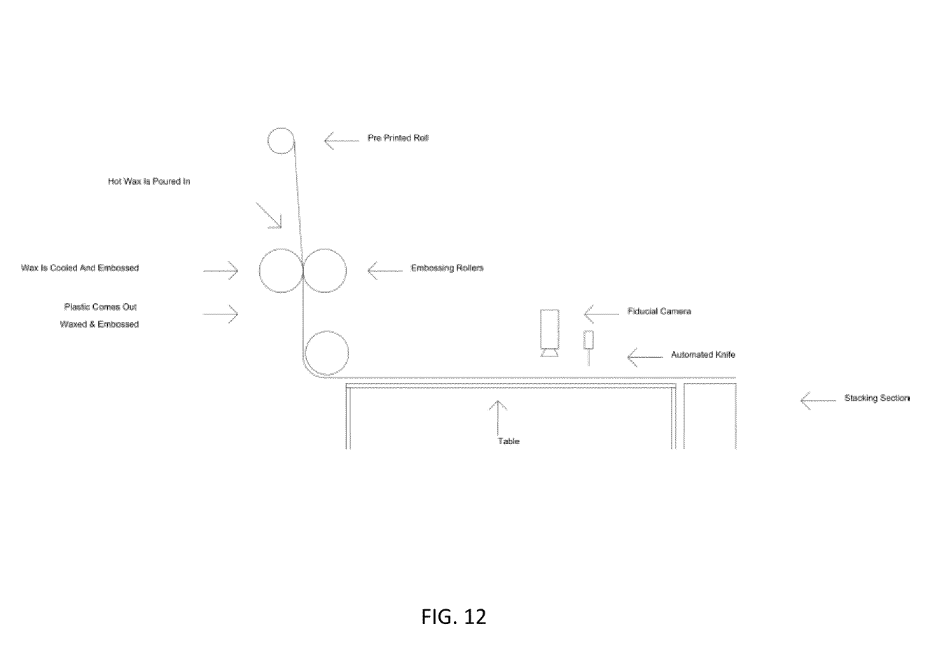

FIG. 12 is a diagram illustrating a method and process for applying wax to a Compostable Circuit Board. The wax and its cell design are embossed onto the compostable circuit board allowing for a variance in the size and quantity of cells. The film for the Compostable Circuit Board may be produced on a roll then fed into an embossing machine for fast production. Each individual board is identified on the roll using fiducials allowing each board to be cut, identified and recognizable through the wax.

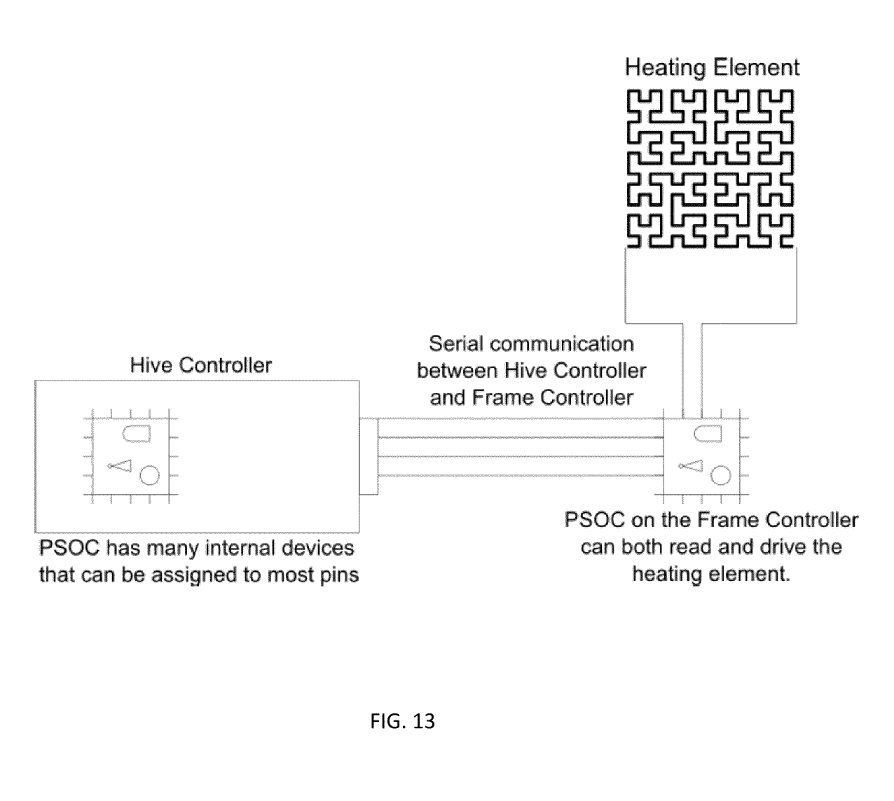

FIG. 13 is a diagram illustrating the use of a Programmable System-on-Chip (“PSoC”) to drive the technology for the hive monitoring system 150. The PSoC makes use of MODBUS (a serial communications protocol) to communicate with the driver circuit making it easier to connect to other equipment. Additionally, the PSoC enables the use of the same pins to drive both heating the elements and switching it to read current for temperature measurement. Essentially, this enables the heating elements to both operate as a device for heating and a reading temperature similar to a thermistor.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the system is not intended to be exhaustive or to limit the system to the precise form disclosed above. While specific embodiments of, and examples for, the system are described above for illustrative purposes, various equivalent modifications are possible within the scope of the system, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

While many embodiments described above employ software stored on the mobile device, the scripts and other software noted above may be hard coded into the mobile device (e.g. stored in EEPROM, PROM, etc.). Further, the above functionality may be implemented without scripts or other special modules.

The teachings of the system provided herein can be applied to other systems, not necessarily the system described above. The elements and acts of the various embodiments described above can be combined to provide further embodiments.

All of the above patents and applications and other references, including any that may be listed in accompanying filing papers, are incorporated by reference. Aspects of the system can be modified, if necessary, to employ the systems, functions, and concepts of the various references described above to provide yet further embodiments of the system.

These and other changes can be made to the system in light of the above Detailed Description. While the above description details certain embodiments of the system and describes the best mode contemplated, no matter how detailed the above appears in text, the system can be practiced in many ways. Details of the system may vary considerably in its implementation details, while still being encompassed by the system disclosed herein. As noted above, particular terminology used when describing certain features or aspects of the system should not be taken to imply that the terminology is being redefined herein to be restricted to any specific characteristics, features, or aspects of the system with which that terminology is associated. In general, the terms used in the following claims should not be construed to limit the system to the specific embodiments disclosed in the specification, unless the above Detailed Description section explicitly defines such terms. Accordingly, the actual scope of the system encompasses not only the disclosed embodiments, but also all equivalent ways of practicing or implementing the system under the claims.

While certain aspects of the system are presented below in certain claim forms, the inventors contemplate the various aspects of the system in any number of claim forms. Accordingly, the inventors reserve the right to add additional claims after filing the application to pursue such additional claim forms for other aspects of the system.

We claim:

1. A system, comprising:
multiple gates configured to be positioned proximate to an entrance of a beehive, each of the gates including:
one or more sensors configured to capture information indicating a bee is within the gate and information indicating the bee is traveling toward or away from the entrance to the beehive; and
a sensor configured to capture information identifying a size or shape of a bee within the gate.

2. The system of claim 1, wherein the one or more sensors configured to capture information indicating a bee is within the gate and information indicating the bee is traveling toward or away from the entrance to the beehive include two or more infrared photo transistors; and wherein at least one interior surface of the gate is black.

3. The system of claim 1, wherein the sensor configured to capture information identifying a size or shape of a bee within the gate is an RGB phototransistor.

4. The system of claim 1, wherein the sensor configured to capture information identifying a size or shape of a bee within the gate is an infrared phototransistor.

5. The system of claim 1, wherein the sensor configured to capture information identifying a size or shape of a bee within the gate is configured to capture information indicative of a mite attached to the bee within the gate.

6. The system of claim 1, wherein the sensor configured to capture information identifying a size or shape of a bee within the gate is configured to capture information indicative of a biological substance attached to the bee within the gate.

7. The system of claim 1, wherein the system is configured to use the sensor configured to capture information identifying a size or shape of a bee within the gate to capture information indicative of a mite attached to the bee within the gate.

8. The system of claim 1, wherein the system is configured to use the sensor configured to capture information identifying a size or shape of a bee within the gate to capture information indicative of one or more other biological substances attached to the bee within the gate.

9. The system of claim 8, wherein said other biological substances include at least one member of a group consisting of pollen, water, nectar, propolis, and fungus.

10. The system of claim 1, further comprising temperature sensing circuitry configured to enable the system to detect when cells within the beehive are capped.

11. The system of claim 10, wherein the system is configured to trigger a treatment process upon detection of cells being capped.

12. The system of claim 11, wherein the treatment process includes treating the capped cells with localized heat.

13. The system of claim 11, wherein the treatment process includes applying a chemical treatment to the capped cells.

14. The system of claim 11, wherein the treatment process is designed to sterilize mites within the capped cells.

15. A method, comprising:
capturing information associated with a bee traveling in or out of a beehive;
determining a size or shape of the bee based on the captured information; and
identifying a type of the bee based on the determined size or shape of the bee.

16. The method of claim 15, wherein capturing information associated with a bee traveling in or out of a beehive includes capturing the information when the bee is within a gate proximate to a beehive via one or more sensors configured to capture information indicating the bee is within the gate and information indicating the bee is traveling toward or away from the entrance to the beehive, and via a sensor configured to capture information identifying a size or shape of a bee within the gate.

17. A method, comprising:
capturing information associated with a bee traveling in or out of a beehive;
identifying an object attached or proximate to the bee based on the captured information.

18. The method of claim 17, wherein capturing information associated with a bee traveling in or out of a beehive includes capturing the information when the bee is within a gate proximate to a beehive via one or more sensors configured to capture information indicating the bee is within the gate and information indicating the bee is traveling toward or away from the entrance to the beehive, and via a sensor configured to capture information indicating the object is attached or proximate to the bee.

19. The method of claim 17, wherein capturing information associated with a bee traveling in or out of a beehive includes capturing a color pattern indicative of pollen that is attached to the bee.

20. The method of claim 17, wherein capturing information associated with a bee traveling in or out of a beehive includes capturing a color pattern indicative of a mite that is attached to the bee.

21. A method, comprising:
determining a hive state for a beehive;
comparing the determined hive state to a baseline hive state; and
performing an action based on the comparison.

22. The method of claim 21, wherein determining a hive state for a beehive includes:
determining, for a first type of bee, a number of bees of the first type within the beehive and a number of bees of the first type outside of the beehive; and
determining, for a second type of bee, a number of bees of the second type within the beehive and a number of bees of the second type outside of the beehive.

23. The method of claim 21, wherein determining a hive state for a beehive includes:
determining a number of bees within the beehive; and
determining a number of bees outside of the beehive.

24. The method of claim 21, wherein determining a hive state for a beehive includes determining a number of bees having attached mites within the beehive.

25. The method of claim 21, wherein performing an action based on the comparison includes generating a report that indicates the determined hive state is abnormal.

26. The method of claim 21, wherein performing an action based on the comparison includes generating an alert that indicates the determined hive state is abnormal.

27. The method of claim 21, wherein performing an action based on the comparison includes generating a report that indicates an abnormal condition associated with a crop proximate to the beehive and pollinated by at least one bee of the beehive.

28. A computer-readable medium whose contents, when executed by a computing system, cause the computing system to perform operations, comprising:
determining a current number of worker bees within a beehive and a current number of worker bees outside of the beehive, the beehive having a known range of a total number of worker bees associated with the beehive;
determining a current number of drone bees within a beehive and a current number of drone bees outside of the beehive, the beehive having a known range of a total number of drone bees associated with the beehive; and
performing an action based on the determined numbers.
